(19) United States
(12) Patent Application Publication
(10) Pub. No.: US 2009/0200433 A1
(43) Pub. Date: Aug. 13, 2009

(54) MOUNTING FLANGE CONFIGURATION FOR EXHAUST COMPONENT

(76) Inventors: Jeffrey P. Hayes, Camby, IN (US); Kevin C. Kocher, Shelbyville, IN (US)

Correspondence Address: PAMELA A. KACHUR, 950 W 450 S, BLDG. 4, COLUMBUS, IN, 47201, US

(21) Appl. No.: 12/030,256

(22) Filed: Feb. 13, 2008

(51) Int. Cl. F16L 3/08; E21F 17/02; F16L 3/00

(52) U.S. Cl. 248/58; 248/65

(57) ABSTRACT

A mounting flange assembly for connecting adjoining exhaust components includes first and second pieces. One flange piece includes at least one first mount hole that extends in one direction and at least one second mount hole that extends in another direction. The first mount hole secures the first piece to one exhaust component and the second mount hole secures the first and second pieces together. Another exhaust component is attached to an opposite side of the first flange piece. The orientation of the first and second mount holes provides a sealed joint between the mating exhaust components while additionally providing improved service access.

### TECHNICAL FIELD

The subject invention relates to a mounting flange configuration for a vehicle exhaust component with improved serviceability access.

### BACKGROUND OF THE INVENTION

Exhaust systems are widely known and used with combustion engines. Typically, an exhaust system includes exhaust tubes that convey hot exhaust gases from the engine to other exhaust system components, such as converters, mufflers, resonators, etc. Each of the various exhaust components is mounted to an adjacent component at a mount interface. As such, each exhaust system includes a plurality of mount interfaces between adjoining components.

One such example of a mount interface is the interface between a converter assembly and a cylinder head or manifold. Traditionally, this mount interface includes a flange mount member with a center opening that defines part of an exhaust gas flow path extending from the converter assembly and through an opening in the cylinder head. In one configuration, the flange mount member includes four mount holes that are used to fasten the flange mount member to the cylinder head. The converter assembly includes a tube portion that is connected to the flange mount member on an opposite side from the cylinder head.

One disadvantage with this traditional configuration is that it is often difficult to perform service and maintenance operations. Specifically, it can be difficult to reach the lower two mount holes such that the converter assembly can be unfastened from the cylinder head.

One proposed solution has been to provide a two-piece mount flange configuration. A first or lower flange piece includes two mount holes and is fastened to the cylinder head along a bottom edge of the opening in the cylinder head. A second flange piece includes a ring-shaped body with a center opening and a bottom edge that abuts against the lower flange piece at a location between the two lower mount holes. The ring-shaped body includes two upper mount holes that are used to fasten the second flange piece to the cylinder head near an upper edge of the opening in the cylinder head. The converter assembly is attached to the second flange piece.

To service the converter assembly only the two upper fasteners, i.e. the two fasteners for the second flange piece, have to be removed. The first or lower flange piece remains fastened to the cylinder head. While this configuration improves serviceability, it introduces additional challenges. As the converter assembly is only secured to the cylinder head with two upper fasteners, there is not a good seal interface between the converter assembly and the cylinder head. As such, the use of the two-piece flange configuration with four bolts, only two of which are used to secure the converter assembly to the cylinder head, does not provide a tightly sealed joint, which is disadvantageous from a performance perspective.

Thus, there is a need for a mount interface between exhaust components that provides improved serviceability while also providing a tightly sealed joint.

### SUMMARY OF THE INVENTION

A mount flange piece for connecting adjoining vehicle exhaust components includes first and second mount holes that extend in different directions to provide a tightly sealed joint, as well as providing easy serviceability.

In one example, a mounting flange assembly for connecting first and second exhaust components together includes first and second pieces. The first piece includes at least one first mount hole that extends in a first direction and at least one second mount hole that extends in a second direction that is different from the first direction. The first piece is attached to the first exhaust component at the first mount hole. The second piece is separately attached to the first exhaust component, and the second piece is attached to the first piece via the second mount hole.

In one example, the first piece comprises a ring-shaped body with a center opening that defines an exhaust gas flow path between the first and second exhaust components. The ring shaped body includes the first and second mount holes, with the first mount hole being used to secure the first piece to the first exhaust component. The second piece comprises a linear body portion that includes at least one third mount hole that is aligned with the second mount hole. The second piece also includes at least one fourth mount hole that is used to secure the second piece to the first exhaust component. The connection between the second and third mount holes pulls the first and second pieces together to provide a tightly sealed joint connection.

In one example, the first and fourth mount holes extend in the first direction and are parallel to, and spaced apart from, each other. The second and third mount holes extend in the second direction and are coaxial with each other. In one example, the second direction is perpendicular to the first direction.

In one example, the at least one first, second, third, and fourth mount holes comprise a pair of first mount holes, a pair of second mount holes, a pair of third mount holes, and a pair of fourth mount holes, respectively.

One example assembly method is as follows. The linear body portion of the second piece is first fastened to the first exhaust component via the fourth mount holes. Then, the ring-shaped body is attached to the linear body portion via the interface between the second and third mount holes. Then, the ring-shaped body is attached to the first exhaust component via the first mount holes. The second exhaust component is attached to the ring-shaped body. In one example, the second exhaust component is attached to the ring-shaped body prior to attachment of the first and second pieces to the first exhaust component.

The first piece, i.e. the ring-shaped body, with the associated second exhaust component can be easily removed from the first exhaust component by removing fasteners from the first and second mount holes while the second piece, i.e. the linear body portion, remains fastened to the first exhaust component.

As such, the use of first and second pieces, along with the orientation of the first/fourth and second/third mount holes provides a sealed joint between the mating exhaust components while additionally providing improved service access. These and other features of the present invention can be best understood from the following specification and drawings, the following of which is a brief description.

### BRIEF DESCRIPTION OF THE DRAWINGS

FIG. 1 is a perspective view of a portion of an exhaust system showing a mount interface between first and second exhaust components.

FIG. 2A is a perspective view of a first piece of the mount interface.

FIG. 2B is an end view of the first piece of FIG. 2A.

FIG. 2C is a side view of the first piece of FIG. 2A.

FIG. 3A is a perspective view of a second piece of the mount interface.

FIG. 3B is an end view of the second piece of FIG. 3A.

FIG. 3C is a side view of the second piece of FIG. 3A.

FIG. 4A is a perspective view of the first and second pieces secured together as viewed from a cylinder head or exhaust manifold side of the mount interface.

FIG. 4B is perspective view of the first and second pieces from FIG. 4A as viewed from a converter side of the mount interface.

FIG. 4C is a side view of FIG. 4A.

### DETAILED DESCRIPTION OF THE PREFERRED EMBODIMENT

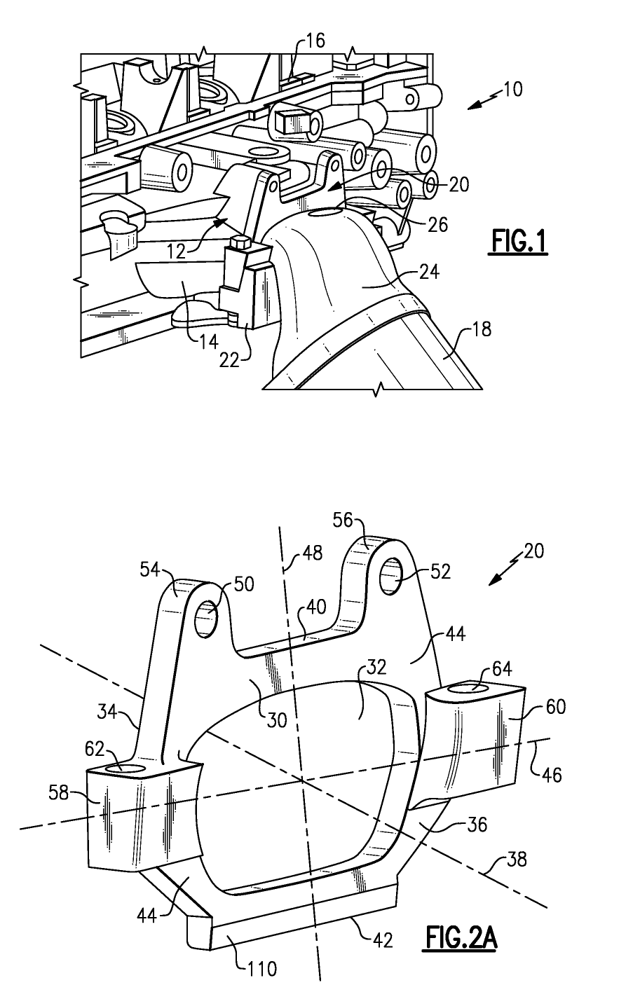

An example of a portion of an exhaust system including a cylinder head mount area indicated generally at 10 is shown in FIG. 1. As known, the exhaust system is comprised of a plurality of components, converters, mufflers, resonators, etc., which convey hot exhaust gases from an engine to the external atmosphere. Each of the various exhaust components is mounted to an adjacent component at a mount interface. As such, each exhaust system includes a plurality of mount interfaces between adjoining components.

An example of one such mount interface 12 is shown in FIG. 1, and is between a manifold or a cylinder head 14 of an engine 16 and a converter assembly 18. The mount interface 12 comprises a flange attachment that is used to attach the converter assembly 18 directly to the cylinder head 14 to define an exhaust gas flow path. The mount interface 12 includes a first piece 20 that is attached to the cylinder head 14 and a separate, second piece 22 that is attached to the cylinder head 14 independently of the first piece 20. The first 20 and second 22 pieces are also attached to each other.

The converter assembly 18 includes a tube portion 24 that is attached to the first piece 20. In one example, the tube portion 24 is welded to the first piece 20 as indicated at 26. Due to the two-piece configuration, the first piece 20 and the associated converter assembly 18 can be removed from the cylinder head 14 without having to remove the second piece 22 from the cylinder head 14. This improves serviceability of the exhaust system and will be discussed in greater detail below. Further, it should be noted that while the two-piece flange attachment mount interface is shown as being used between a cylinder head and a converter assembly, this attachment interface could also be used as an interface between other adjoining exhaust system components.

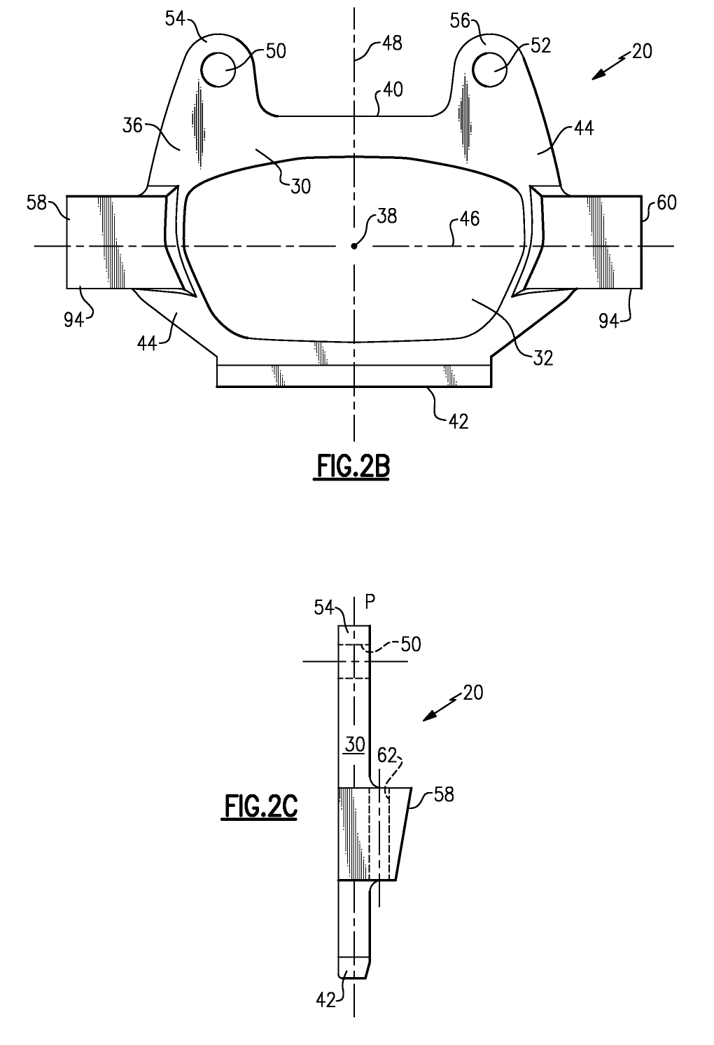

The first piece 20 is shown in greater detail in FIGS. 2A-2C. The first piece 20 includes a ring-shaped body 30 with a center opening 32 that defines a portion of the exhaust gas flow path between the cylinder head 14 and the converter assembly 18. In the example shown, the center opening 32 has a non-circular cross-section; however, the opening could be defined by other cross-sectional shapes.

The ring-shaped body 30 includes a first side 34 that faces the cylinder head 14 and an opposite second side 36 that faces the converter assembly 18. The center opening 32 defines a centerline 38 of the exhaust gas flow path. The ring-shaped body 30 includes an upper edge portion 40, a lower edge portion 42, and side edge portions 44 that connect the upper 40 and lower 42 edge portions. The ring-shaped body 30 is further defined by a horizontal centerline 46 that intersects the centerline 38 of the exhaust gas flow path and a vertical centerline 48 that also intersects the centerline 38 of the exhaust gas flow path.

Positioned above the horizontal centerline 46 are first 50 and second 52 mount holes that extend in a first direction that is generally parallel to the centerline 38 at the center opening 32. The first 50 and second 52 mount holes are formed within first 54 and second 56 bosses that are formed in the upper edge portion 40 of the ring-shaped body 30. The first 54 and second 56 bosses are positioned on opposite sides of the vertical centerline 48 from each other.

Also positioned on opposite sides of the vertical centerline 48 from each other are third 58 and fourth 60 bosses. The third boss 58 includes a third mount hole 62 and the fourth boss 60 includes a fourth mount hole 64. The third 62 and fourth 64 mount holes extend in a direction that is generally parallel to the vertical centerline 48. As such, in this example, the first 50 and second 52 mount holes extend in a direction that is generally perpendicular to the third 62 and fourth 64 mount holes.

As shown most clearly in FIG. 2C, the ring-shaped body 30 is defined by a central plane P that extends in the direction of the vertical centerline 48 (FIG. 2B). The first 54 and second 56 bosses are generally centrally located relative to this central plane P. In the example shown, the third 58 and fourth 60 bosses include portions that extend out of the central plane P.

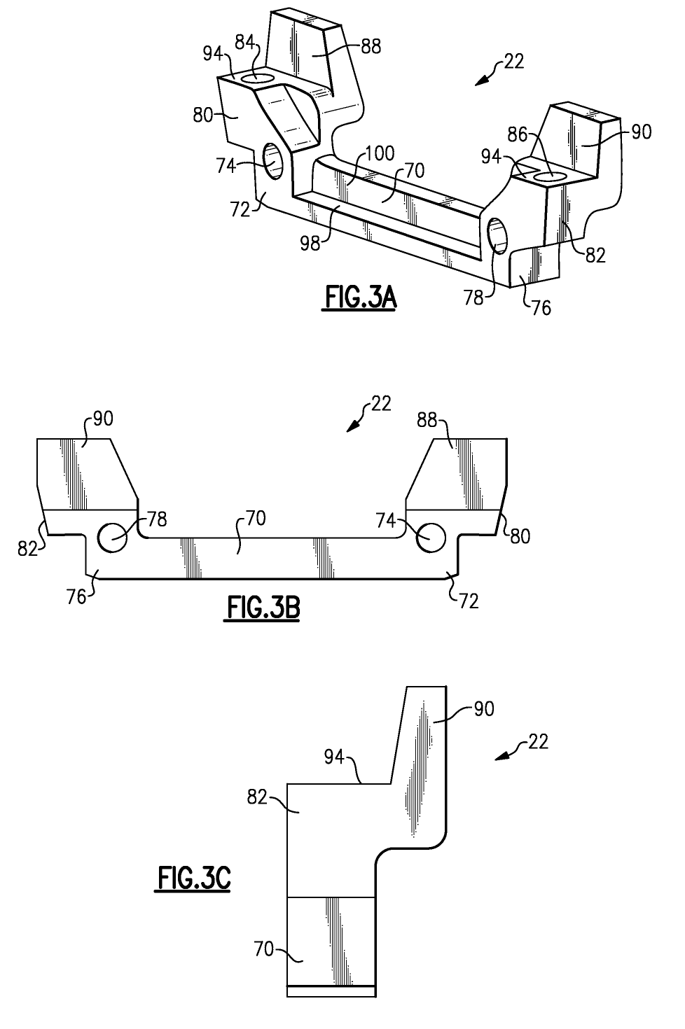

The second piece 22 is shown in greater detail in FIGS. 3A-3C. The second piece 22 includes a linear body portion 70 that extends in a direction that is generally parallel to the horizontal centerline 46. The linear body portion 70 has a first end 72 with a first mount hole 74 and an opposite second end 76 with a second mount hole 78. The first 74 and second 78 mount holes extend in a direction that is generally parallel to a direction in which the first 50 and second 52 mount holes of the first piece 20 extend, i.e. the first 74 and second 78 mount holes extend in a direction that is generally parallel to the centerline 38 at the center opening 32. The first 74 and second 78 mount holes are used to attach the second piece 22 to the cylinder head.

A first boss 80 is formed at the first end 72 of the linear body portion 70 and a second boss 82 is formed at the second end 76 of the linear body portion 70. A third mount hole 84 is formed within the first boss 80 and a fourth mount hole 86 is formed within the second boss 82. The third 84 and fourth 86 mount holes extend in a direction that is generally parallel to the third 62 and fourth 64 mount holes of the first piece 20, i.e. the third 84 and fourth 86 mount holes extend in a direction that is generally parallel to the vertical centerline 48.

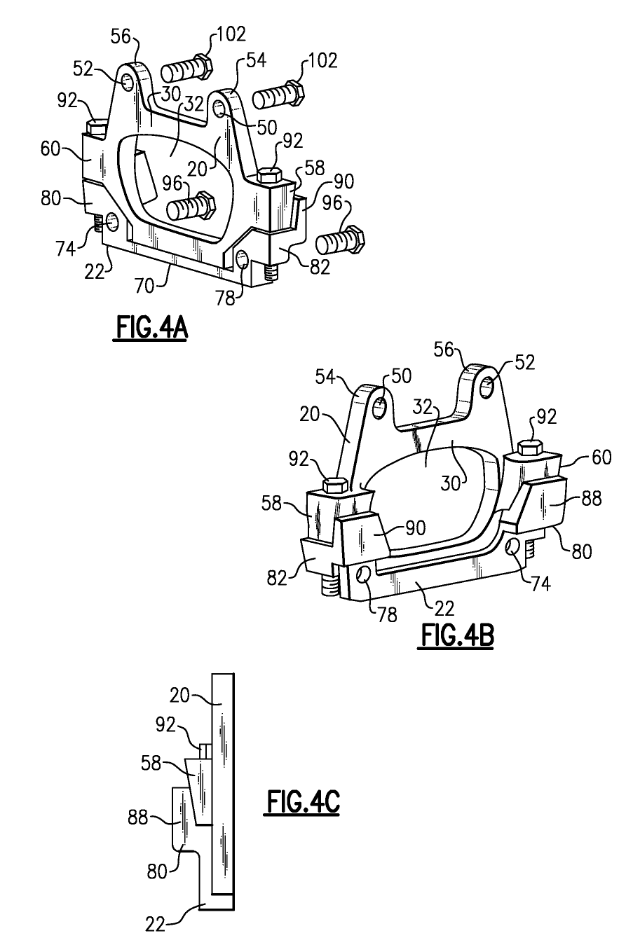

The first boss 80 includes a first flange portion 88 and the second boss 82 includes a second flange portion 90. When the first 20 and second 22 pieces are attached to each other, one side of the third 58 and fourth 60 bosses of the first piece 20 abut against the second 90 and first 88 flange portions of the second piece 22, respectively. In this position, the third 84 and fourth 86 mount holes of the second piece 22 are aligned with the fourth 64 and third 62 mount holes, respectively, of the first piece 20. When these holes are aligned, fasteners 92 (FIG. 4A-4C) are used to secure the first 20 and second 22 pieces together.

As the fasteners 92 are installed, the first 20 and second 22 pieces are drawn tightly together at corresponding abutment surfaces 94 to provide a tightly sealed connection joint as shown in FIGS. 1 and 4A-4C. This is similar to mechanical pipe joint connections for attaching two adjoining flange portions of plumbing pipe together.

The method of connecting the converter assembly 18 to the cylinder head 14 includes the following steps. First, the second piece 22 is attached to the cylinder head 14 by installing fasteners 96 (FIG. 4A) through the first 74 and second 78 mount holes of the linear body portion 70. Next, the first piece 20 is attached to the second piece 22. A bottom edge of the lower edge portion 42 of the first piece 20 rests against a horizontal ledge surface 98 of the linear body portion 70. A vertical ledge surface 100 of the linear body portion 70 abuts against a corresponding abutment surface 110 on the second side 36 of the lower edge portion 42 of the ring-shaped body 30. The third boss 58 of the first piece 20 is in abutting engagement with the second boss 82 of the second piece 22 at the corresponding abutment surfaces 94. Also, the fourth boss 60 of the first piece 20 is in abutting engagement with the first boss 80 of the second piece 22 at the corresponding abutment surfaces 94. In this configuration the third mount hole 62 of the first piece 20 is aligned and coaxial with the fourth mount hole 86 of the second piece 22, and the fourth mount hole 64 of the first piece 20 is aligned and coaxial with the third mount hole 84 of the second piece 22.

Once the first piece 20 is properly positioned relative to the second piece, the fasteners 92 are installed and tightened to securely fix the first 20 and second 22 pieces together. As the fasteners 92 are tightened, the first 50 and second 52 mount holes of the first piece 20 are brought into alignment with corresponding mount holes (not shown) in the cylinder head 14. Then fasteners 102 (FIG. 4A) are installed through the first 50 and second 52 mount holes to secure the first piece 20 to the cylinder head 14.

As such, the first 20 and second 22 pieces are separately mounted to the cylinder head 14 and are also attached to each other. The tube portion 24 of the converter assembly 18 is welded or similarly attached to the first piece 20 prior to the first 20 and second 22 pieces being attached to the cylinder head 14. When service or maintenance operations are required, the fasteners 92 and 102 are removed and the first piece 20 and the associated converter assembly 18 are easily removed from the cylinder head 14 without having to remove the second piece 22 from the cylinder head 14. In other words, the converter assembly 18 can be easily removed from the cylinder head 14 without having to have access to the lower fasteners 96.

Further, a mechanical advantage is utilized for parallel non-vertical surfaces that drive the first piece 20, i.e. a converter assembly flange, toward a mount face of the cylinder head 14. This creates a sufficient amount of force to seal the connection joint to keep exhaust gases from escaping. The relative vertical movement and force is generated during installation of the fasteners 92 that pass through clearance holes, i.e. the third 62 and fourth 64 mount holes of the first piece 20, and thread into tapped holes, i.e. the third 84 and fourth 86 mount holes of the second piece. As such, the fasteners 92 and 102 are easily accessible from above the converter assembly 18, which provides improved serviceability.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A mount assembly for a vehicle exhaust component comprising:
a first flange piece including at least one first mount hole extending in a first direction and at least one second mount hole extending in a second direction different than said first direction.

2. The mount assembly for a vehicle exhaust component according to claim 1 wherein said first and said second directions are perpendicular to each other.

3. The mount assembly for a vehicle exhaust component according to claim 1 wherein said at least one first mount hole is to receive at least one first fastener for securement of said first flange piece to a vehicle exhaust component.

4. The mount assembly for a vehicle exhaust component according to claim 3 wherein said at least one second mount hole is to receive at least one second fastener to secure said first flange piece to a second flange piece.

5. The mount assembly for a vehicle exhaust component according to claim 1 wherein said first flange piece comprises a single-piece, ring-shaped body having a center opening that forms a portion of an exhaust gas flow path, said ring-shaped body including a first mounting boss extending outwardly from an outer circumference of said ring-shaped body with said at least one first mount hole being formed within said first mounting boss, and said ring-shaped body including a second mounting boss with said at least one second mount hole being formed within said second mounting boss.

6. The mount assembly for a vehicle exhaust component according to claim 5 wherein said center opening is non-circular.

7. The mount assembly for a vehicle exhaust component according to claim 5 including a second flange piece with at least one third mount hole that is aligned with said at least one second mount hole such that said first and said second flange pieces can be secured together with a fastener.

8. The mount assembly for a vehicle exhaust component according to claim 7 wherein said second flange piece includes at least one fourth mount hole that is generally parallel to said at least one first mount hole when said first and said second flange pieces are secured together, and wherein said at least one first mount hole receives a fastener for securement of said first flange piece to a vehicle exhaust component and said at least one fourth mount hole receives a fastener for securement of said second flange piece to the vehicle exhaust component.

9. The mount assembly for a vehicle exhaust component according to claim 7 wherein said second flange piece comprises a generally linear body portion that extends along an edge of said center opening, said linear body portion including an upwardly extending mounting boss that abuts against said second mounting boss of said first flange piece.

10. The mount assembly for a vehicle exhaust component according to claim 1 wherein said first flange piece is mountable to a first exhaust component via said at least one first mount hole and including a second exhaust component secured to said first flange piece at a position opposite from the first exhaust component.

11. A vehicle exhaust assembly comprising:
a mounting flange assembly including a first piece having a ring-shaped body with a center opening that forms a portion of an exhaust gas flow path between first and second exhaust components, said first piece having at least a pair of first mount holes extending in a first direction for securement of said first piece to said first exhaust component, and said first piece having at least a pair of second mount holes extending in a second direction different from said first direction, and said mounting flange assembly including a second piece having at least a pair of third mount holes that are aligned with said pair of second mount holes; and
a plurality of fasteners including at least first and second fasteners that are received within aligned second and third mount holes to secure said first and said second pieces together.

12. The vehicle exhaust assembly according to claim 11 wherein said second piece has at least a pair of fourth mount holes that extend generally parallel to said first direction, and wherein said plurality of fasteners includes at least third and fourth fasteners to secure said first piece to said first exhaust component through said pair of first mount holes and fifth and sixth fasteners to secure said second piece to said first exhaust component through said pair of fourth mount holes.

13. The vehicle exhaust assembly according to claim 12 wherein said first exhaust component comprises one of a cylinder head and/or a manifold and wherein said second exhaust component comprises a converter assembly.

14. The vehicle exhaust assembly according to claim 12 wherein said second piece comprises a linear body portion extending along an edge portion of said center opening and first and second bosses formed respectively at first and second ends of said linear body portion, with one of said third mount holes being formed within said first boss and the other of said third mount holes being formed within said second boss.

15. The vehicle exhaust assembly according to claim 14 wherein said ring-shaped body includes a first boss formed adjacent one side of said center opening and a second boss formed adjacent an opposite side of said center opening, with one of said first mount holes being formed within said first boss of said ring-shaped body and the other of said first mount holes being formed within said second boss of said ring-shaped body; and wherein said ring-shaped body includes a third boss formed at said one side of said center opening and a fourth boss formed at said opposite side of said center opening, with one of said second mount holes being formed within said third boss and the other of said second mount holes being formed within said fourth boss.

16. The vehicle exhaust assembly according to claim 15 wherein said first boss of said linear body portion directly abuts against said third boss of said ring-shaped body and wherein said second boss of said linear body portion directly abuts against said fourth boss of said ring-shaped body.

17. The vehicle exhaust assembly according to claim 12 wherein said first piece is removable from said second piece and said first exhaust component without having to remove said second piece from said first exhaust component.

18. A method of assembling first and second exhaust components together comprising:
(a) fastening a first flange piece to a first exhaust component;
(b) fastening a second flange piece to the first flange piece, the second flange piece being adapted to receive a second exhaust component; and
(c) fastening the second flange piece to the first exhaust component.

19. The method according to claim 18 wherein steps (a) and (c) include installing fasteners in a first direction and step (b) includes installing fasteners in a second direction different from the first direction.

20. The method according to claim 18 wherein step (b) is performed subsequent to step (c) and step (a) is performed subsequent to step (b).
